(19) United States
(12) Patent Application Publication
(10) Pub. No.: US 2025/0258785 A1
(43) Pub. Date: Aug. 14, 2025

(54) CONTROL UNIT AND STORAGE DEVICE INCLUDING THE SAME

(71) Applicant: SK hynix Inc., Icheon-si (KR)

(72) Inventor: Young Jo KIM, Icheon-si (KR)

(21) Appl. No.: 19/019,001

(22) Filed: Jan. 13, 2025

(30) Foreign Application Priority Data
Feb. 8, 2024 (KR) 10-2024-0019388

(51) Int. Cl. G06F 13/16

(52) U.S. Cl. CPC G06F 13/1689

(57) ABSTRACT

A storage device adjusts the timing of processing a command based on an address of a memory area where operations, such as data preservation, are performed and an address associated with a command transmitted by a host device. This adjustment enhances the operational performance of a storage device by improving the efficiency of command processing while maintaining the data preservation state of the memory. The storage device may include at least one memory, and a control unit for controlling the at least one memory to perform an operation of writing data to, or reading data from, a second memory area of the at least one memory during a first period, while a data preservation operation for a first memory area of the at least one memory is in progress.

### CROSS-REFERENCES TO RELATED APPLICATION

The present application claims priority under 35 U.S.C. 119 (a) to Korean patent application number 10-2024-0019388 filed on Feb. 8, 2024, which are incorporated herein by reference in its entirety.

### TECHNICAL FIELD

Embodiments of the disclosure relate to a control unit and a storage device including the same.

### BACKGROUND

A storage device may include at least one memory storing data. The storage device may write data to or read data from the memory in response to a command received from an external source.

The processing of the command may be delayed based on the operation state of the memory. As a result, the delay time between when the command is received and when the command is processed may increase. This increase in delay time can negatively impact the performance of the storage device.

### SUMMARY

Embodiments of the present disclosure provide a method for enhancing the operation performance of a storage device by adjusting the timing and method of processing a command received from an external device, based on the operation state of memory included in the storage device.

Embodiments of the disclosure may provide a storage device comprising at least one memory and a control unit communicating between the at least one memory and a host device, and controlling the at least one memory, wherein the control unit includes a memory controller controlling an operation of the at least one memory, a data preserve operation manager managing a data preserve operation of the at least one memory, and a buffer manager receiving a command transmitted by the host device and storing the command in a buffer memory if an address according to the command is included in an address area where the data preserve operation is in progress and, if the address is not included in the address area, providing the command to the memory controller.

Embodiments of the disclosure may provide a storage device comprising at least one memory and a control unit controlling the at least one memory, and controlling an operation of writing data to a second memory area of the at least one memory or an operation of reading data written to the second memory area during a first period when a data preserve operation for a first memory area of the at least one memory is in progress.

Embodiments of the disclosure may provide a control unit comprising a first interface communicating with a host device, a second interface communicating with a memory, controlling an operation of the memory, and outputting information about a data preserve operation of the memory, and a buffer manager obtaining a command received through the first interface and storing the command in a buffer memory if an address according to the command is included in an address area where the data preserve operation is in progress and, if the address is not included in the address area, providing the command to the second interface.

According to embodiments of the present disclosure, the timing and method of processing a command are adjusted based on the operation state of memory included in a storage device and the type of the command received from an external device. This adjustment reduces the delay time associated with the processing of the command and enhances the operation performance of the storage device.

### BRIEF DESCRIPTION OF THE DRAWINGS

FIG. 1 is a view illustrating a schematic configuration of a storage device according to an embodiment of the present disclosure;

FIG. 2 is a view illustrating a schematic configuration of a control unit included in a storage device according to an embodiment of the present disclosure;

FIG. 3 is a view illustrating a configuration of a control unit according to an embodiment of the present disclosure;

FIGS. 4 to 7 are views illustrating an operation method of a storage device according to an embodiment of the present disclosure; and

FIGS. 8 to 10 are views illustrating an operation method of a control unit according to an embodiment of the present disclosure.

### DETAIL DESCRIPTION OF THE EXEMPLARY EMBODIMENTS

In the following description of examples or embodiments of the disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the disclosure, detailed descriptions of well-known functions and components incorporated herein will be omitted when it is determined that the description may make the subject matter in some embodiments of the disclosure rather unclear. The terms such as “including,” “having,” “containing,” “constituting,” “make up of,” and “formed of” used herein are generally intended to allow other components to be added unless the terms are used with the term “only.” As used herein, singular forms are intended to include plural forms unless the context clearly indicates otherwise.

Terms, such as “first,” “second,” “A,” “B,” “(A),” or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to” or “contacts or overlaps” a second element, it should be interpreted that, not only can the first element “be directly connected or coupled to” or “directly contact or overlap” the second element, but a third element can also be “interposed” between the first and second elements, or the first and second elements can “be connected or coupled to” or “contact or overlap” each other via a fourth element. Here, the second element may be included in at least one of two or more elements that “are connected or coupled to” or “contact or overlap” each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can.”

Hereinafter, various embodiments of the present disclosure will be described in detail with reference to accompanying drawings.

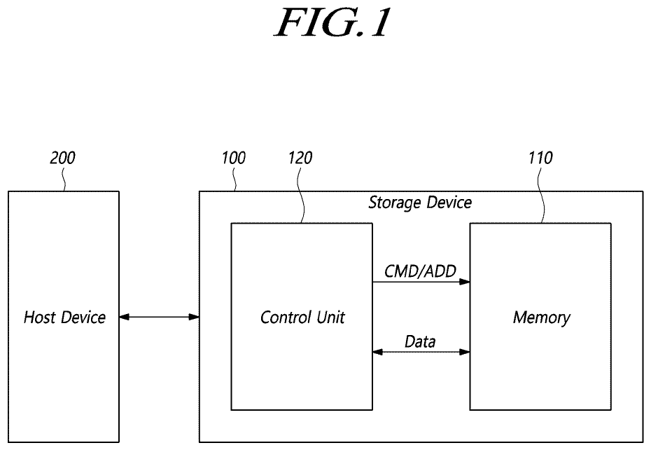

FIG. 1 is a view illustrating a schematic configuration of a storage device 100 according to an embodiment of the present disclosure.

Referring to FIG. 1, the storage device 100 may include at least one memory 110. The storage device 100 may further include a control unit 120 that controls the operation of the memory 110.

The memory 110 may include a volatile memory such as DRAM, SDRAM, DDR SDRAM, LPDDR SDRAM, or the like, but embodiments of the present disclosure are not limited thereto. The memory 110 may include a nonvolatile memory such as a NAND flash memory, a three-dimensional (3D) NAND flash memory, a NOR flash memory, or the like.

Further, the memory 110 may be one of various types of memories such as resistive RAM, phase change memory, magnetoresistive memory, ferroelectric memory, spin injection magnetization inversion memory, or the like. Further, the memory 110 may be a processing-in-memory including an arithmetic function or a data processing function, in some cases. In the present disclosure, the memory 110 may also be referred to as a memory device.

The memory 110 may include a plurality of storage blocks. Each of the plurality of storage blocks may include a plurality of memory cells. The plurality of storage blocks may be divided into a plurality of banks, which are units controlled by the control unit 120.

The control unit 120 may receive a command from an external device and control the operation of the memory 110 based on the received command. Further, the control unit 120 may control the operation of the memory 110 based on a command generated therein.

The control unit 120 may transmit a command or address for controlling the operation of the memory 110 to the memory 110. The control unit 120 may control, e.g., an operation of writing data to the memory 110. The control unit 120 may control an operation of reading data from the memory 110. Data may be transmitted and received between the control unit 120 and the memory 110.

The control unit 120 may control a data preservation operation (e.g., a refresh operation or a patrol scrub operation) or an erase operation on data stored in the memory 110 according to the type of the memory 110.

The control unit 120 may control the operation of the memory 110 based on a command received from an external host device 200.

The host device 200 may be, e.g., a computer, an ultra-mobile PC (UMPC), a workstation, a personal digital assistant (PDA), a tablet, a mobile phone, a smartphone, an e-book, a portable multimedia player (PMP), a portable game console, a navigation device, a black box, a digital camera, a digital camera, a digital multimedia broadcasting (DMB) player, a smart television, a digital voice recorder, a digital voice player, a digital video recorder, a digital video player, storage constituting a data center, one of various electronic devices constituting a telematics network, a radio frequency identification (RFID) device, a moving device (e.g., a vehicle, robot, or drone) capable of driving under human control or autonomous driving, or the like. Alternatively, the host device 200 may be a virtual/augmented reality device that provides two-dimensional (2D) or three-dimensional (3D) virtual reality images or augmented reality images. The host device 200 may be any one of various electronic devices that require the storage device 100 capable of storing data.

The host device 200 may include at least one operating system. The operating system may generally manage and control the functions and operations of the host device 200, and may control mutual operations between the host device 200 and the storage device 100. The operating system may be divided into a general operating system and a mobile operating system according to the mobility of host device 200.

The control unit 120 and the host device 200 may be devices separated from each other. In some cases, the control unit 120 and the host device 200 may be integrated and implemented as one device, or some components or functions of the control unit 120 may be implemented to be included in the host device 200. Hereinafter, for convenience of description, an example is described in which the control unit 120 and the host device 200 are separated from each other.

The control unit 120 may communicate with the host device 200 and control the memory 110. The control unit 120 may adjust the time and scheme of processing the command according to the operation state of the memory 110 and the type of the command transmitted from the host device 200. By the control of the control unit 120, the efficiency of processing the command of the host device 200 may be increased, and the operation performance of the storage device 100 may be prevented from being deteriorated due to the operation state of the memory 110.

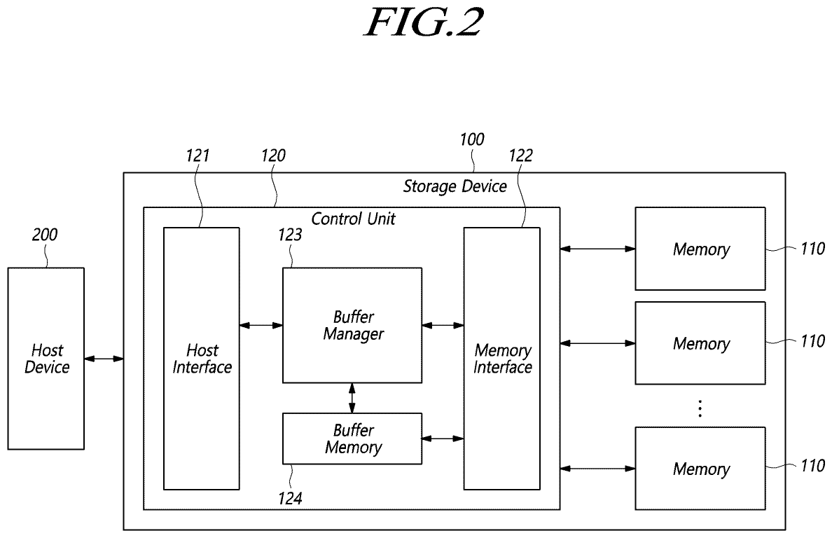

FIG. 2 is a view illustrating a schematic configuration of a control unit 120 included in a storage device 100 according to an embodiment of the present disclosure.

Referring to FIG. 2, the storage device 100 may include at least one memory 110 and the control unit 120 that controls the memory 110. The storage device 100 may include a plurality of memories 110. The control unit 120 may control the plurality of memories 110, and may include components for controlling each of the plurality of memories 110 and components for performing a common function.

The control unit 120 may include components for communicating with the host device 200. The control unit 120 may include components for communicating with the memory 110 and controlling the memory 110.

The control unit 120 may be implemented as a single chip or as a package including a plurality of chiplets. When the control unit 120 is implemented with the plurality of chiplets, each of the plurality of chiplets may be functionally divided or may be divided according to the memory 110 to be controlled.

The control unit 120 may include a host interface 121 and a memory interface 122.

The host interface 121 may facilitate communication between the control unit 120 and the host device 200. The host interface 121 may be a compute express link (CXL) interface. The host device 200 may be set as a CXL root port, and the storage device 100 may be set as a CXL endpoint. Since the host device 200 communicates with the storage device 100 through the CXL interface, a low-delay, high-bandwidth access environment may be implemented in a structure of communicating with the high-capacity storage device 100.

Further, in some cases, the host interface 121 may be one of various interfaces other than the CXL interface.

For example, the host interface 121 may support at least one of various interface protocols such as a universal serial bus (USB) protocol, a multimedia card (MMC) protocol, a peripheral component interconnection (PCI) protocol, a PCI-express (PCI-E) protocol, an advanced technology attachment (ATA) protocol, a serial-ATA protocol, a parallel-ATA protocol, a small computer small interface (SCSI) protocol, an enhanced small disk interface (ESDI) protocol, and an integrated drive electronics (IDE) protocol, but embodiments of the present disclosure are not limited thereto.

The memory interface 122 may facilitate communication with the memory 110. The memory interface 122 may include components for controlling or managing the operation of the memory 110. In some cases, the memory interface 122 refers to a physical layer responsible for communication with the memory 110, while the components for controlling and managing the memory 110 may be implemented separately from the memory interface 122.

In the present disclosure, the host interface 121 may be referred to as a first interface, and the memory interface 122 may be referred to as a second interface.

The control unit 120 may further include a buffer manager 123 and a buffer memory 124.

The buffer manager 123 may communicate with the host interface 121 and receive a command and/or data transmitted by the host device 200 through the host interface 121.

The buffer manager 123 may transfer data to the host device 200 through the host interface 121. In some cases, data may be transmitted to the host device 200 directly from the memory interface 122 through the host interface 121, bypassing the buffer manager 123.

The buffer manager 123 may communicate with the memory interface 122 and obtain information about the operation state of the memory 110.

The buffer manager 123 may control the timing and method of processing the command transmitted by the host device 200, based on the command received through the host interface 121 and the information about the operation state of the memory 110 received through the memory interface 122.

When the buffer manager 123 directly processes the command based on the type of the command transferred by the host device 200 and the operation state of the memory 110, the buffer manager 123 may transfer the received command to the memory interface 122.

The memory interface 122 may control the operation of the memory 110 based on the command transferred through the buffer manager 123.

When the buffer manager 123 does not directly process the command transmitted by the host device 200, the buffer manager 123 may store the received command in the buffer memory 124. The buffer manager 123 may manage the command stored in the buffer memory 124 and monitor the operation state of the memory 110.

When the buffer manager 123 is ready to process the command stored in the buffer memory 124, the buffer manager 123 may provide the command to the memory interface 122.

The memory interface 122 may receive the command from the buffer memory 124 and control the operation of the memory 110 based on the received command.

The timing and method of processing the command may be adjusted under the control of the buffer manager 123, and the processing efficiency of the command may be enhanced according to the operation state of the memory 110.

When storing the command transmitted by the host device 200 in the buffer memory 124, the buffer manager 123 may transmit a response signal to the host device 200 through the host interface 121 to confirm the storage of the command in the buffer memory 124. Since the control circuit 120 manages the command processing within the storage device 100 and transmits the response signal to the host device 200, the delay due to data processing between the host device 200 and the storage device 100 can be reduced.

The buffer manager 123 may adjust the timing and method of processing the command transmitted by the host device 200 based on various operation states of the memory 110. For example, the buffer manager 123 may control the method of processing the command based on an operation of preserving data stored in the memory 110.

In an embodiment, the control unit 120 may be implemented with one or more processors, storage devices, or a combination thereof. Specifically, some components of the control unit 120, such as the host interface 121, the memory interface 122, and the buffer manager 123, may perform certain functions using processor(s). However, embodiments are not limited to this configuration.

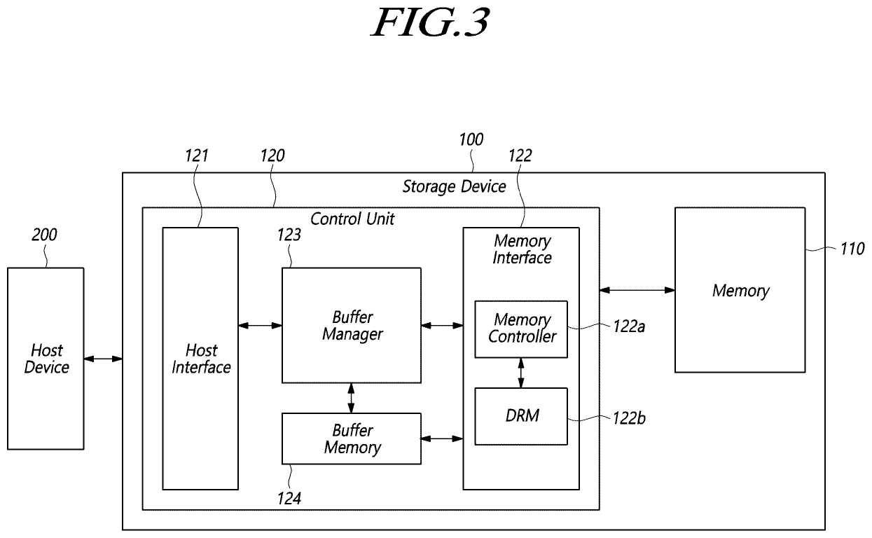

FIG. 3 is a view illustrating a configuration of a control unit 120 according to an embodiment of the disclosure.

Referring to FIG. 3, a storage device 100 may include a memory 110 and the control unit 120. The control unit 120 may include a host interface 121, a memory interface 122, a buffer manager 123, and a buffer memory 124.

The buffer memory 124 may be separate from the buffer manager 123 or integrated within the buffer manager 123. The buffer memory 124 may be a cache memory or an SRAM, but is not limited thereto.

The memory interface 122 may include a memory controller 122a and a data preservation operation manager (DRM) 122b.

The control unit 120 may include the memory controller 122a and the data preservation operation manager 122b to correspond to each of the memories 110 included in the storage device 100. The memory controller 122a and the data preservation operation manager 122b may be implemented separately or, in some cases, integrated.

The memory controller 122a may control the operation of the memory 110, including writing data to the memory 110 or reading data from the memory 110.

In some cases, the memory controller 122a may control the operation of preserving data stored in the memory 110 or an operation of erasing data stored in the memory 110.

The data preservation operation manager 122b may manage the operation of preserving data stored in the memory 110. The data preservation operation may refer to an operation such as a refresh operation or a patrol scrub operation, which involves rewriting data stored in the memory 110.

The operation of rewriting data stored in at least a partial area of the memory 110 at predetermined intervals or times may be performed. The data preservation operation manager 122b may manage the timing, affected areas, and related information for the data preservation operation on the memory 110.

Information related to the data preservation operation managed by the data preservation operation manager 122b may be provided to the buffer manager 123.

The buffer manager 123 may identify the operation state of the memory 110 based on the information received from the data preservation operation manager 122b. The buffer manager 123 may control the timing and method of processing the command transmitted by the host device 200 based on information about the progress of the data preservation operation on the memory 110.

Data stored in the memory 110 may be preserved through the data preservation operation, ensuring that the delay due to command processing of the host device 200 is minimized.

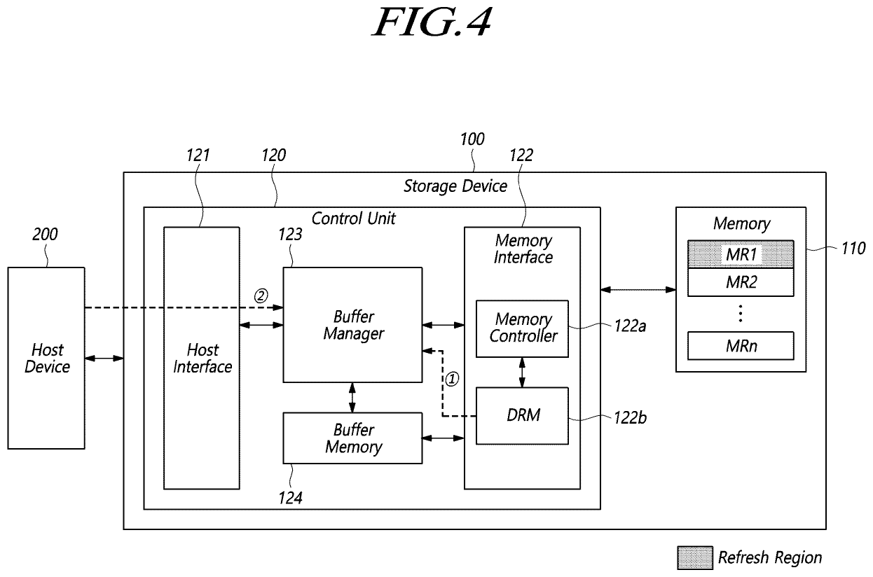

FIGS. 4 to 7 are views illustrating an operation method of a storage device 100 according to an embodiment of the present disclosure. Although FIGS. 4 to 7 show an example with a single memory 110 included in the storage device 100, embodiments of the present disclosure are also applicable when a plurality of memories 110 are included.

Referring to FIG. 4, the memory 110 may include a plurality of memory areas MR1, MR2, . . . , MRn. The memory area may refer to a storage block having a predetermined size. The size of the memory area may correspond to a unit in which the data preservation operation is performed.

The memory 110 may perform a data preservation operation at predetermined intervals or a specified time.

Although the data preservation operation is described as a refresh operation in this example, it may encompass various operations performed to preserve data stored in the memory 110.

Although this example illustrates a scheme in which the buffer manager 123 processes a command transmitted by the host device 200 during the data preservation operation of the memory 110, embodiments of the present disclosure may also apply to other operations of the memory 110 that require a command to be held in standby, in addition to the data preservation operation.

A refresh operation may be performed on a first memory area MR1 among the plurality of memory areas MR1, MR2, . . . , MRn included in the memory 110.

The refresh operation may be managed by the data preservation operation manager 122b, which controls the timing and memory area for the refresh operation. The memory controller 122a may control the refresh operation of the memory 110 based on refresh information provided by the data preservation operation manager 122b. Alternatively, the memory 110 may perform the refresh operation in response to a signal transmitted by the memory controller 122a.

Alternatively, the refresh operation may be managed by the memory controller 122a. In this case, the memory controller 122a may control the refresh operation and provide relevant information about the refresh operation to the data preservation operation manager 122b.

When the refresh operation for the first memory area MR1 of the memory 110 starts, the data preservation operation manager 122b may transmit a start signal for the refresh operation to the buffer manager 123, as shown in \textcircled{1}.

The data preservation operation manager 122b may transmit the start signal and an end signal for the refresh operation to the buffer manager 123.

The data preservation operation manager 122b may transmit the start signal for the refresh operation, along with information about the memory area in which the refresh operation is being performed, to the buffer manager 123.

The information about the memory area in which the refresh operation is being performed may include address information about the corresponding memory area.

Alternatively, the information about the memory area in which the refresh operation is being performed may include start address information for the corresponding memory area. The refresh operation may be performed in predetermined memory area size units.

Information about the size of the memory area in which the refresh operation is performed may be transmitted to the buffer manager 123 along with the start address information. Alternatively, the information about the size of the memory area in which the refresh operation is performed may be pre-stored in the buffer manager 123 and need not be transmitted by the data preservation operation manager 122b.

When transmitting the end signal for the refresh operation to the buffer manager 123, the data preservation operation manager 122b may or may not transmit address information about the memory area in which the refresh operation has been completed to the buffer manager 123.

The buffer manager 123 may receive information about the refresh operation from the data preservation operation manager 122b.

The buffer manager 123 may receive a command transmitted by the host device 200, as shown in \textcircled{2}.

The host interface 121 may transfer the command received from the host device 200 to the buffer manager 123. At least some of commands received through the host interface 121 may be transferred to the memory interface 122 through the buffer manager 123, rather than being directly transmitted to the memory interface 122.

The host interface 121 may transfer the command transmitted by the host device 200, along with the address associated with the command, to the buffer manager 123.

The address associated with the command may be a logical address. The host interface 121 may include a decoder that converts the logical address transmitted by the host device 200 into a physical address of the memory 110 or an address managed by the memory controller 122a.

If the buffer manager 123 receives the command from the host interface 121, the buffer manager 123 may compare the address associated with the command with the address of the memory area in which the refresh operation is being performed, received from the data preservation operation manager 122b.

The buffer manager 123 may control the method of processing the command based on the comparison result between the address associated with the command and the address of the memory area in which the refresh operation is being performed.

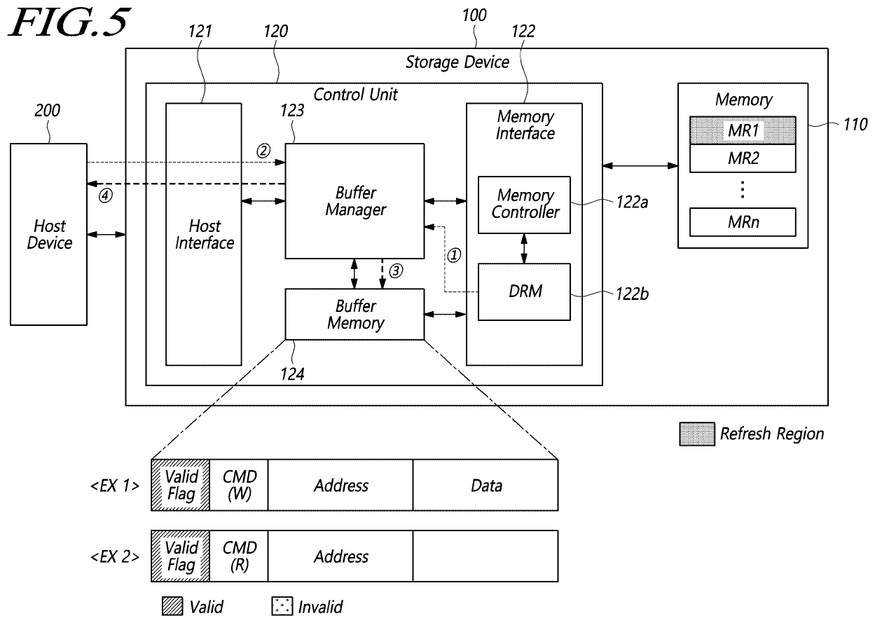

Referring to FIG. 5, an example is illustrated where the address of the command received by the buffer manager 123 corresponds to the address of the first memory area MR1 in which the refresh operation is being performed.

If the address associated with the command transmitted by the host device 200 corresponds to the address of the first memory area MR1, the buffer manager 123 may transmit the command to the buffer memory 124, as shown in \textcircled{3}.

The buffer manager 123 may store the command and its corresponding address in the buffer memory 124. The buffer manager 123 may store data in the buffer memory 124 depending on the type of the command.

For example, when the command transmitted by the host device 200 is a write command, the buffer manager 123 may store the command, the address, and write data in the buffer memory 124, as shown in <EX 1>.

The buffer manager 123 may set a valid flag of the command stored in the buffer memory 124.

For example, the buffer manager 123 may set the valid flag of the command stored in the buffer memory 124 to a first value. The command with the valid flag set to the first value may indicate that the command requires processing once the refresh operation for the first memory area MR1, which includes the address associated with the command, is completed.

When storing the write command in the buffer memory 124, the buffer manager 123 may check whether the address associated with the write command matches any of addresses of write commands previously stored in the buffer memory 124.

When the address associated with the write command received from the host device 200 is already stored in the buffer memory 124, i.e., when the address associated with the write command matches any one of the addresses stored in the buffer memory 124, the buffer manager 123 may set the valid flag of the received write command to the first value and store it in the buffer memory 124.

The buffer manager 123 may change the valid flag of the write command already stored in the buffer memory 124 to a second value. The command with the valid flag set to the second value may be considered invalid, indicating that the command does not require processing after the refresh operation is completed.

Alternatively, when the address associated with the write command received from the host device 200 is already stored in the buffer memory 124, the buffer manager 123 may overwrite data of the already stored write command with the write data of the received write command, while maintaining the valid flag of the already stored write command as the first value.

When the buffer manager 123 stores the write command, the address, and the write data in the buffer memory 124, the buffer manager 123 may transmit a response signal to the host device 200 through the host interface 121, as shown in \textcircled{4}. Upon receiving the response signal, the host device 200 may recognize that the write command has been processed, and can transmit the next necessary command to the storage device 100 without delay.

As another example, when the command transmitted by the host device 200 is a read command, the buffer manager 123 may store the read command and its corresponding address in the buffer memory 124, as shown in <EX 2>.

The buffer manager 123 may set the valid flag of the read command stored in the buffer memory 124 to the first value.

The buffer manager 123 may check whether the address associated with the read command matches any of the addresses already stored in the buffer memory 124.

If the address associated with the read command matches an address associated with a write command already stored in the buffer memory 124, the buffer manager 123 may provide data of the already stored write command to the host device 200. In particular, the buffer manager 123 may check the valid flag of the already stored write command and, if the valid flag is set to the first value, provide the data of the already stored write command to the host device 200.

As described above, when providing the data to the host device 200 in response to the read command, the buffer manager 123 may choose not to store the read command in the buffer memory 124. Alternatively, the buffer manager 123 may store the read command in the buffer memory 124 and set the valid flag of the read command to the second value.

If the address associated with the command transmitted by the host device 200 corresponds to the address of the first memory area MR1 undergoing the refresh operation, the buffer manager 123 may either store the command in the buffer memory 124 or process the command based on the command and data that are already stored in the buffer memory 124, as described above.

Even when a command targeting the first memory area MR1 undergoing the refresh operation is received, the buffer manager 123 may reduce the average delay time required to process the command.

The buffer memory 124 may have a size capable of storing commands from the host device 200 during a period when the refresh operation is in progress.

For example, the size of the buffer memory 124 may correspond to the product of the duration of the first period, during which the refresh operation for the first memory area MR1 is in progress, and the data transmission speed between the host device 200 and the storage device 100 (specifically, the control unit 120). Specifically, the size of the buffer memory 124 is smaller than or equal to the product. Alternatively, considering the data transmission efficiency (e.g., 0.8) between the host device 200 and the storage device 100, the size of the buffer memory 124 may be adjusted to a value obtained by multiplying the above-described product by the data transmission efficiency.

As such, the processing and management of the command received during the period when the refresh operation is in progress may be facilitated by appropriately setting the size of the buffer memory 124.

Once the refresh operation is complete or the memory area undergoing the refresh operation is changed, the buffer manager 123 may process the command stored in the buffer memory 124.

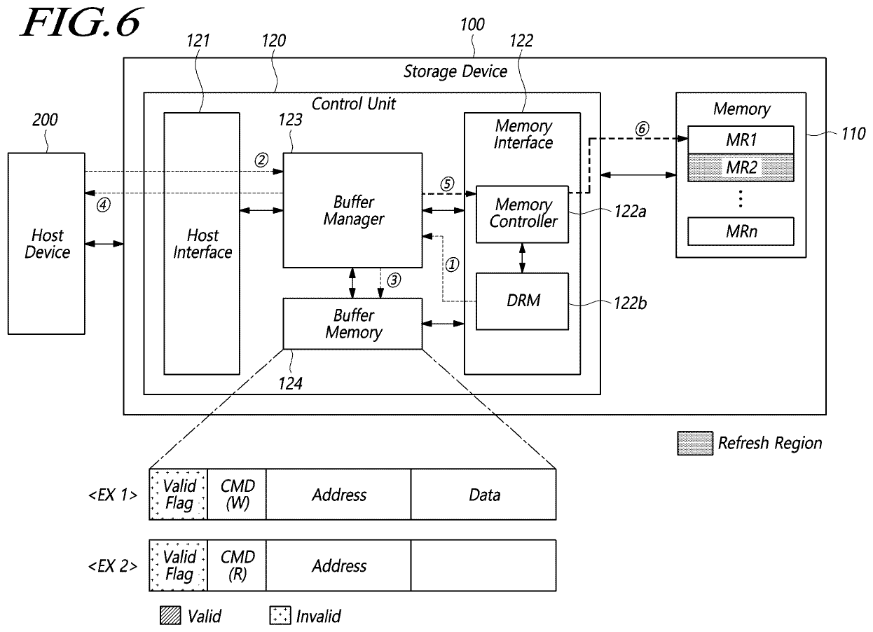

For example, as illustrated in FIG. 6, the refresh operation on the first memory area MR1 of the memory 110 may be complete.

There may be a predetermined time interval between the completion of the refresh operation for the first memory area MR1 and the initiation of the next refresh operation. Alternatively, the refresh operation for the first memory area MR1 may conclude, followed by the commencement of the refresh operation for the second memory area MR2.

The duration during which the refresh operation for the first memory area MR1 is performed may be referred to as a first period, while the duration during which the refresh operation for the second memory area MR2 is performed may be referred to as a second period.

When the first period ends, the data preservation operation manager 122b may transmit an end signal of the refresh operation for the first memory area MR1 to the buffer manager 123. Similarly, when the second period starts, the data preservation operation manager 122b may transmit a start signal of the refresh operation for the second memory area MR2 to the buffer manager 123. A time interval may exist between the first period and the second period, or the first period and the second period may be continuous.

If the buffer manager 123 receives the end signal of the refresh operation for the first memory area MR1, the buffer manager 123 may process the command related to the first memory area MR1 that is stored in the buffer memory 124.

The buffer manager 123 may provide a command associated with an address of the first memory area MR1, among the commands stored in the buffer memory 124 with a valid flag set to the first value, to the memory controller 122a, as shown in \textcircled{5}.

When the command stored in the buffer memory 124 is a write command, the buffer manager 123 may provide the write command, its corresponding address, and write data stored in the buffer memory 124 to the memory controller 122a. When the command stored in the buffer memory 124 is a read command, the buffer manager 123 may provide the read command and its corresponding address stored in the buffer memory 124 to the memory controller 122a.

Upon receiving the command from the buffer manager 123, the memory controller 122a may control an operation corresponding to the command for the first memory area MR1, as shown in \textcircled{6}.

The memory controller 122a may control an operation of writing data, in response to the write command stored in the buffer memory 124, to the first memory area MR1.

Alternatively, the memory controller 122a may control an operation of reading data from the first memory area MR1 in response to the read command stored in the buffer memory 124. The memory controller 122a may provide the read data to the host interface 121 through the buffer manager 123 or may directly provide the read data to the host interface 121.

When the command stored in the buffer memory 124 is provided to the memory controller 122a, the buffer manager 123 may change the valid flag of the command stored in the buffer memory 124 to the second value.

Alternatively, when the memory controller 122a completes processing the command, the buffer manager 123 may change the valid flag of the command stored in the buffer memory 124 to the second value.

When the refresh operation for the first memory area MR1 is complete, the command for the first memory area MR1 is processed, thereby minimizing the delay time for the command processing.

Further, since the command for the first memory area MR1 is processed during the second period, while the refresh operation for another memory area, such as the second memory area MR2, is in progress, the delay caused by the command processing can be reduced even during the refresh operation.

Further, when the address associated with the command transmitted by the host device 200 corresponds to a memory area other than the memory area undergoing the refresh operation, the command can be processed without delay.

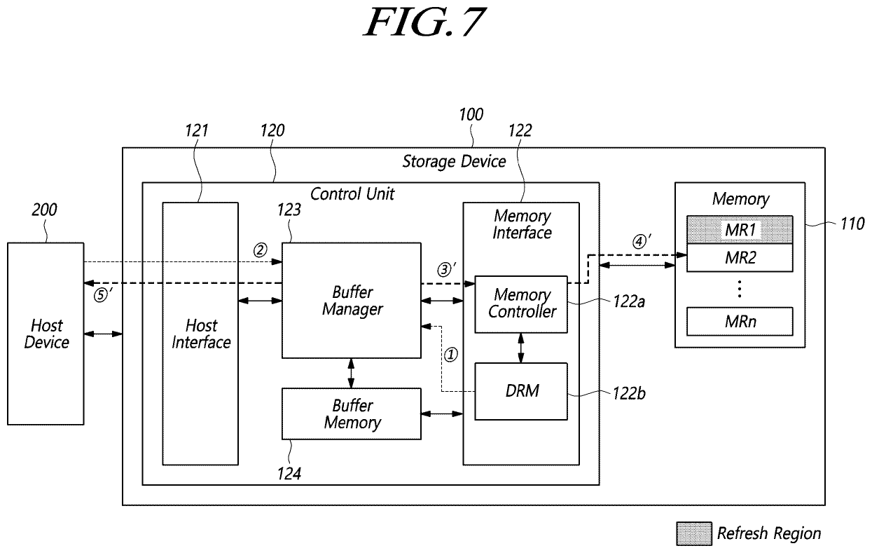

For example, referring to FIG. 7, the buffer manager 123 may receive information about the refresh operation for the first memory area MR1 from the data preservation operation manager 122b, as shown in \textcircled{1}. Additionally, the buffer manager 123 may receive the command transmitted by the host device 200 through the host interface 121, as shown in \textcircled{2}.

The buffer manager 123 may check whether the address associated with the received command corresponds to the first memory area MR1 undergoing the refresh operation.

For example, when the address associated with the received command corresponds to the second memory area MR2, where no refresh operation is in progress, the buffer manager 123 may provide the received command to the memory controller 122a, as shown in \textcircled{3}′.

The buffer manager 123 may provide the received command directly to the memory controller 122a without utilizing the buffer memory 124, or it may route the command through the buffer memory 124 before providing it to the memory controller 122a.

The buffer manager 123 may provide the received command and its corresponding address to the memory controller 122a. Depending on the type of the command, the buffer manager 123 may also provide relevant data to the memory controller 122a.

The memory controller 122a may control the operation of the memory 110 based on the command received from the buffer manager 123.

The memory controller 122a may control the operation for the second memory area MR2, as shown in \textcircled{4}′, during the first period when the refresh operation for the first memory area MR1 is in progress.

The memory controller 122a may control the operation of writing data to the second memory area MR2 in the first period. Alternatively, the memory controller 122a may control the operation of reading data from the second memory area MR2 in the first period.

Once the memory controller 122a completes the processing of the command, it may transmit a response signal for the write command or data corresponding to the read command to the host device 200, as shown in \textcircled{5}′. The memory controller 122a may transmit a signal directly to the host interface 121 or route the signal through the buffer manager 123.

In the first period while the refresh operation for the first memory area MR1 is in progress, a command for a memory area other than the first memory area MR1, such as the second memory area MR2, may be processed.

Even during the refresh operation for the memory 110, the command transmitted by the host device 200 can be processed without waiting. This approach helps maintain the preserved state of data stored in the memory 110 while reducing the delay in command processing by the host device 200,enhancing the operation performance of the storage device 100, including the memory 110.

The buffer manager 123 included in the control unit 120 may be implemented to manage the command processing while facilitating communication between the host interface 121 and the memory interface 122, as described in the above example. The buffer manager 123 can be integrated into the host interface 121 or the memory interface 122.

The buffer manager 123 may refer to a component within the control unit 120 that receives and processes commands from the host device 200, along with information regarding the data preservation operation of the memory 110.

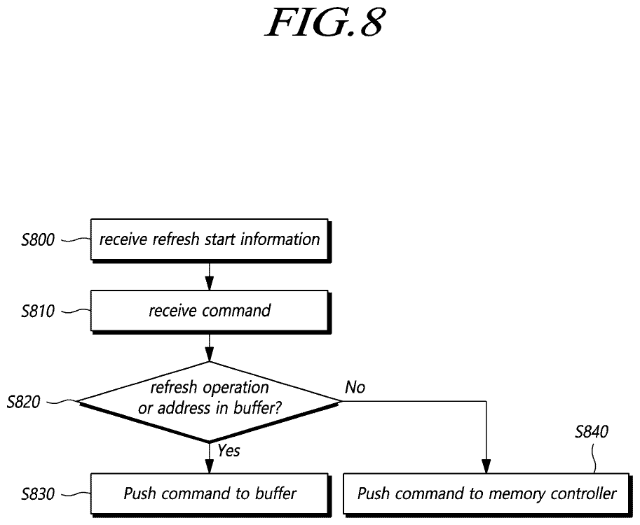

FIGS. 8 to 10 are views illustrating an operation method of the control unit 120 according to an embodiment of the disclosure.

Referring to FIG. 8, the buffer manager 123 included in the control unit 120 may receive refresh start information related to a refresh operation of the memory 110 (S800).

The buffer manager 123 may identify a memory area undergoing the refresh operation using the refresh start information. The buffer manager 123 may predict the duration of the refresh operation based on the refresh start information.

The buffer manager 123 may receive a command input from the host device 200 while continuously obtaining real-time information about the refresh operation (S810).

The command transmitted from the host device 200 to the storage device 100 may be inputted to the buffer manager 123 through the host interface 121.

The buffer manager 123 may check whether an address associated with the received command corresponds to the memory area undergoing the refresh operation or matches any address stored in the buffer memory 124 (S820).

The buffer manager 123 may send the command to the buffer memory 124 if the address associated with the received command corresponds to the memory area undergoing the refresh operation (S830). Further, the buffer manager 123 may send the received command to the buffer memory 124 if the address associated with the received command matches any address stored in the buffer memory 124 and corresponds to a command in a valid state.

If the address associated with the received command does not correspond to the memory area undergoing the refresh operation, the buffer manager 123 may send the received command to the memory controller 122a (S840), where the command may be performed.

The buffer manager 123 may manage the command received from the host device 200, and the command may be transferred to the memory controller 122a for processing even during the refresh operation. This enhances operation performance of the storage device 100.

The buffer manager 123 may control the timing and method of processing the command based on the memory area undergoing the refresh operation and the address associated with the command.

When the address associated with the command corresponds to the memory area undergoing the refresh operation, the buffer manager 123 may process the command based on factors such as the type of command, whether its corresponding command stored in the buffer memory 124 is valid, or other relevant conditions.

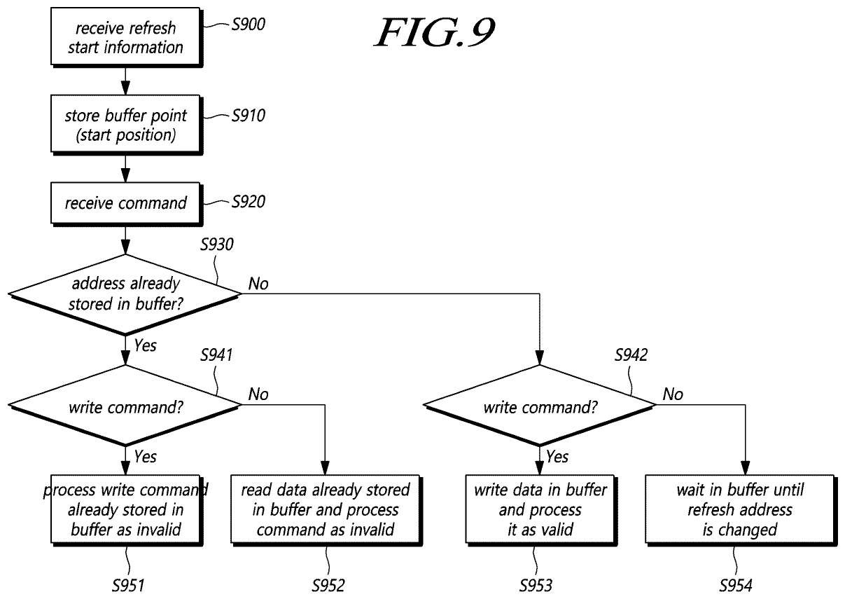

For example, referring to FIG. 9, the buffer manager 123 receives refresh start information (S900). The buffer manager 123 may store a buffer point corresponding to the start position of the refresh operation in the buffer memory 124 based on the refresh start information (S910). The buffer manager 123 then manages a command received after the refresh operation begins, based on the start position.

After storing the buffer point in the buffer memory 124, the buffer manager 123 receives a command transmitted by the host device 200 (S920). When an address associated with the received command corresponds to a memory area undergoing the refresh operation, the buffer manager 123 may check whether the address associated with the received command matches any address associated with a command previously stored in the buffer memory 124 (S930). That is, at S930, the buffer manager 123 checks whether the address associated with the received command is already stored in the buffer memory 124.

When the address associated with the received command matches the address stored in the buffer memory 124 (S930: Yes), the buffer manager 123 may check whether the received command is a write command (S941).

If the received command is a write command (S9410: Yes), the buffer manager 123 may store the received command in the buffer memory 124, set its valid flag to the first value, and change a valid flag of the previously stored command in the buffer memory 124 to the second value, marking it as invalid (S951). In some cases, the buffer manager 123 may overwrite the previously stored command with the received command.

On the other hand, if the received command is a read command (S941: No), the buffer manager 123 may read data corresponding to a write command stored in the buffer memory 124 and provide it to the host device 200. The buffer manager 123 may either not store the received read command in the buffer memory 124 or store it with the valid flag set to the second value, managing it as an invalid command (S952). In this case, an address associated with the write command stored in the buffer memory 124 matches the address associated with the received command.

When the address associated with the received command does not match any address stored in the buffer memory 124 (S930: No), the buffer manager 123 may check whether the received command is a write command (S942).

If the received command is a write command (S942: Yes), the buffer manager 123 may store the received command in the buffer memory 124 and set its valid flag to the first value (S953).

If the received command is a read command (S942: No), the buffer manager 123 may hold it in the buffer memory 124 until the refresh operation is complete (S954). Similar to the write command, the buffer manager 123 may store the read command and its address in the buffer memory 124, set its valid flag to the first value, and manage it as a valid command.

The buffer manager 123 may manage commands using the buffer memory 124 and, upon completion of the refresh operation, process the commands stored in the buffer memory 124.

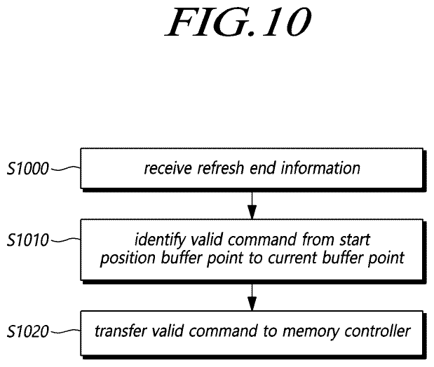

For example, referring to FIG. 10, the buffer manager 123 may receive end information indicating the end of the refresh operation upon its completion (S1000).

Upon receiving the end information about the refresh operation, the buffer manager 123 may identify the command corresponding to the memory area in which the refresh operation is complete. This command is selected from commands stored between the buffer point corresponding to the start position and the current buffer point, with the valid flag set to the first value (S1010).

The buffer manager 123 may transfer data related to the valid command to the memory controller 122a (S1020). The memory controller 122a may perform the operation specified by the valid command on the memory area in which the refresh operation is complete.

According to embodiments of the present disclosure, the buffer manager 123 of the control unit 120 manages refresh operation information and processes commands transmitted by the host device 200. This enables the refresh operation for the memory 110 to be performed while reducing a delay in command processing of the host device 200.

This approach enhances the operation performance of the storage device 100 while preserving data stored in the memory 110.

Further, the buffer manager 123 may obtain information about an operation of the memory 110, other than the refresh operation, and adjust the timing and method of processing commands transmitted by the host device 200 based on an address in which the operation is in progress. This enhances the operation performance of the storage device 100 by increasing the processing efficiency of commands while maintaining the state of the memory 110.

Based on the embodiments of the disclosed technology described above, the operation delay time of the memory system may be significantly reduced or minimized. In addition, the overhead associated with calling specific functions may also be reduced or minimized. While various embodiments of the disclosed technology have been described with specific details for illustrative purposes, those skilled in the art will appreciate that various modifications, additions, and substitutions may be made based on what is disclosed or illustrated in the disclosure without departing from the spirit and scope of the disclosure as defined in the following claims.

What is claimed is:

1. A storage device, comprising:
at least one memory; and
a control unit configured to facilitate communication between the at least one memory and a host device, and control the at least one memory,
wherein the control unit includes:
a memory controller configured to control an operation of the at least one memory;
a data preservation operation manager configured to manage a data preservation operation of the at least one memory; and
a buffer manager configured to receive a command transmitted by the host device, storing the command in a buffer memory when an address associated with the command corresponds to a memory area undergoing the data preserve operation, and providing the command to the memory controller when the address does not correspond to the memory area, the memory area being included in the at least one memory.

2. The storage device of claim 1, wherein, upon receiving a valid command from the buffer manager, the memory controller performs an operation of writing data to a target memory area corresponding to an address associated with the valid command, or an operation of reading data from the target memory area, while the data preservation operation is in progress.

3. The storage device of claim 1, wherein the buffer manager provides the command stored in the buffer memory to the memory controller when the data preservation operation is complete.

4. The storage device of claim 1, wherein the buffer manager transmits a response signal to the host device when the command is stored in the buffer memory.

5. The storage device of claim 1, wherein the buffer manager stores the command, the address associated with the command, and data corresponding to the command in the buffer memory when the command is a write command.

6. The storage device of claim 1, wherein when the command is a write command and the address associated with the command matches an address associated with a write command pre-stored in the buffer memory, the buffer manager sets a valid flag of the command to a first value, stores the valid flag in the buffer memory, and changes a valid flag of the pre-stored write command to a second value, the first value indicating valid and the second value indicating invalid.

7. The storage device of claim 1, wherein when the command is a write command and the address associated with the command matches an address associated with a write command pre-stored in the buffer memory, the buffer manager overwrites the pre-stored write command with the command transmitted by the host device.

8. The storage device of claim 1, wherein the buffer manager stores the command and the address associated with the command in the buffer memory when the command is a read command.

9. The storage device of claim 1, wherein when the command is a read command and the address associated with the command matches an address associated with a write command pre-stored in the buffer memory, the buffer manager provides data corresponding to the pre-stored write command to the host device.

10. The storage device of claim 1, wherein when storing the command in the buffer memory, the buffer manager sets a valid flag of the command to a first value indicating valid.

11. The storage device of claim 10, wherein when providing the command to the memory controller, the buffer manager changes the valid flag of the command to a second value indicating invalid.

12. The storage device of claim 1, wherein the buffer manager receives a start signal and an end signal of the data preservation operation from the data preservation operation manager.

13. The storage device of claim 1, wherein the buffer manager receives information about the memory area and a start signal of the data preservation operation from the data preservation operation manager.

14. The storage device of claim 1, wherein a size of the buffer memory is smaller than or equal to a size corresponding to a product of a duration of a first period during which the data preservation operation is in progress and a data transmission speed between the host device and the control unit.

15. A storage device, comprising:
at least one memory; and
a control unit configured to control the at least one memory to perform an operation of writing data to, or reading data from, a second memory area of the at least one memory during a first period, while a data preservation operation for a first memory area of the at least one memory is in progress.

16. The storage device of claim 15, wherein upon receiving a command for the first memory area during the first period, the control unit stores the command in a buffer memory and sets a valid flag of the command to a first value.

17. The storage device of claim 16, wherein the control unit controls an operation of writing data to, or reading data from, the first memory area based on the command stored in the buffer memory during a second period, while a data preservation operation for the second memory area is in progress after the first period is complete.

18. The storage device of claim 17, wherein the control unit changes the valid flag of the command stored in the buffer memory during the second period to a second value.

19. A control unit, comprising:
a first interface configured to communicate with a host device;
a second interface configured to communicate with a memory, control an operation of the memory, and output information about a data preservation operation being performed on the memory; and
a buffer manager configured to receive a command through the first interface, store the command in a buffer memory when an address associated with the command corresponds a memory area undergoing the data preservation operation, and provide the command to the second interface when the address does not correspond to the memory area.

20. The control unit of claim 19, wherein the second interface controls an operation of writing data to, or reading data from, a second memory area of the memory based on the command during a period, while a data preservation operation for a first memory area of the memory is in progress.
